(19) United States
(12) Patent Application Publication
(10) Pub. No.: US 2022/0294971 A1
(43) Pub. Date: Sep. 15, 2022

(54) COLLABORATIVE OBJECT DETECTION

(71) Applicant: Telefonaktiebolaget LM Ericsson (publ), Stockholm (SE)

(72) Inventors: Fredrik DAHLGREN, LUND (SE); Yun LI, LUND (SE); Saeed BASTANI, DALBY (SE)

(73) Assignee: Telefonaktiebolaget LM Ericsson (publ), Stockholm (SE)

(21) Appl. No.: 17/635,196

(22) PCT Filed: Aug. 15, 2019
(86) PCT No.: PCT/EP2019/071977

§ 371 Date: Feb. 14, 2022

(51) Int. Cl. H04N 5/232; G06V 10/94; G06V 20/40

(52) U.S. Cl. CPC H04N 5/23203; G06V 10/95; G06V 20/40

(57) ABSTRACT

A method performed in a near sensor device (200) connected to a remote device (210) via a communication channel (220), for object detection in a video, the method comprising: detecting at least one object in the video scaled with a first set of scaling parameters (S312), using a first detection model (S314), encoding the video scaled with a second set of scaling parameters (S316), using an encoding quality parameter (S318), streaming the encoded video to the remote device (S320), streaming a side information associated to the encoded video to the remote device, wherein the side information comprises the information of the detected at least one object (S320), receiving a feedback from the remote device (S325), updating the configuration of the near sensor device (200) comprising adapting any of the first set of scaling parameters, the second set of scaling parameters, the first detection model and the encoding quality parameter (S340) based on the received feedback.

### TECHNICAL FIELD

The present invention generally relates to method of object detection and to related systems, devices and computer program products.

### BACKGROUND

Object detection algorithms have been rapidly progressing. Most of the object detection systems have cameras transferring a video stream to a remote end where the video data is either stored or analysed by the object detection algorithms to detect or track objects in the video or is shown to an operator to act upon the event shown in the video. The object detection is carried out based on analysis of images and video that have been previously encoded and compressed. The communication between the cameras and the remote end is realized by wireless networks or other infrastructures, potentially, with limited bandwidth. To fulfill the requirement on bitrate of the communication bandwidth, the video at the image sensor side is downscaled spatially and temporally and compressed in encoding process before being transmitted to a remote end.

In a surveillance system, an object detection is often for identifying human faces. Object detection can also be applied for remotely controlled machines where the objects of interest may be other classes of objects such as electronic cords or water pipes etc in addition to human faces. A multiple class of objects may be identified within a single video. Some objects may be captured with a lower resolution in number of pixels than the other objects (the so-called “small objects”) by a video capturing device (e.g. a camera). Today, many camera sensors have a resolution well above 20 Mpixel. A video stream, on the other hand, is often reduced to 720P having a resolution of 1280 pixels by 720 lines (˜1 Mpixel) or 1080P having a resolution of 1920 pixels by 1080 lines (˜2 Mpixel) due to bitrate limitations when transferring the video to a remote location. Typically, a video frame is downscaled from the camera sensor's original resolution before being encoded and streamed. This means that, even if an object in the original sensor input has a fairly large resolution in number of pixels (e.g. >50 pixels), it might be far below 20 pixels in the downscaled and video coded stream. The situation would be worse for small objects. Many object detection applications suffer from poor accuracy for small objects in complex images. This implies that an algorithm at the remote side might have problems in detecting and classifying such objects.

The above information disclosed in this Background section is only for enhancement of understanding of the background of the invention and therefore it may contain information that does not form the prior art that is already known to a person of ordinary skill in the art.

### SUMMARY

The invention is based on the inventors' realization that the near sensor device has the most knowledge of objects while the remote end can employ advanced object detection algorithms on a video stream from the near sensor device for object detection and tracking. A collaborative detection of objects in video is proposed to improve the object detection performance especially for detecting a class of objects that has relatively low resolution than the other objects in video and are difficult to be detected and tracked in a conventional way.

According to a first aspect, there is provided a method performed in a near sensor device connected to a remote device via a communication channel for object detection in a video. By performing the provided method, at least one object in the video scaled with a first set of scaling parameters is detected using a first detection model, the video scaled with a second set of scaling parameter is encoded using an encoding quality parameter, the encoded video is streamed to the remote device, a side information associated to the encoded video is streamed to the remote device wherein the side information comprises the information of the detected at least one object, a feedback is received from the remote device and the configuration of the near sensor device is selectively updated based on the received feedback, wherein updating the configuration comprising adapting any of the first set of scaling parameters, the second set of scaling parameter, the first detection model and the encoding quality parameter.

According to a second aspect, there is provided a method performed in a remote device connected to a near sensor device via a communication channel for object detection in a video. By performing the provided method, a streaming data comprising an encoded video is received and the encoded video is then decoded, and object detection is performed on the decoded video using a second detection model. Based on partially at least a contextual understanding on any of the decoded video and the output of the object detection, a feedback is determined and provided to the near sensor device.

According to a third aspect, there is provided a computer program comprising instructions which, when executed on a processor of a device for object detection, causes the device to perform the method according to the first and the second aspect.

According to a fourth aspect, there is provided a near sensor device for object detection in video. The near sensor device comprises an image sensor for capturing one or more video frames of the video, an object detector that is configured to detect at least one object in the captured video scaled with a first set of scaling parameters, using a first detection model, an encoder that is configured to encode the captured video scaled with a second set of scaling parameters, using an encoding quality parameter, wherein the encoded video and/or a side information comprising the information of the detected at least one object in the captured video is to be streamed to a remote device, and the near sensor device is configured to communicate with the remote device via a communication interface. The near sensor device further comprises a control unit configured to update the configuration of the near sensor device upon receiving a feedback from the remote device, wherein updating the configuration of the near sensor device comprises adapting any of the first set of scaling parameters, the second set of the scaling parameters, the first detection model and the encoding quality parameter.

According to a fifth aspect, there is provided a remote device for object detection. The remote device comprises a decoder configured to decode an encoded video in a streaming data received from a near sensor device, an object detector configured to detect at least one object in the decoded video using a second detection model, wherein the streaming data comprises the encoded video and/or an associated side information comprising the information of at least one object in the encoded video and the remote device is configured to communicate with the near sensor device via a communication interface. The remote device further comprises a feedback unit configured to determine whether a feedback to the near sensor device is needed, based on partially at least a contextual understanding on any of the received side information, the decoded video and the output of the object detector.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings.

FIG. 1 is block diagram schematically illustrating a conventional object detection system.

FIG. 2 is a block diagram schematically illustrating an object detection system according to an embodiment of the present invention.

FIG. 3 is a flow chart illustrating a method performed in a near sensor device according to an embodiment.

FIG. 4 is a flow chart illustrating a method performed in a remote device according to an embodiment.

FIG. 5 schematically illustrates a computer-readable medium and a processing device.

FIG. 6 illustrates an exemplary object detection system including a near sensor device and a remote device.

### DETAILED DESCRIPTION

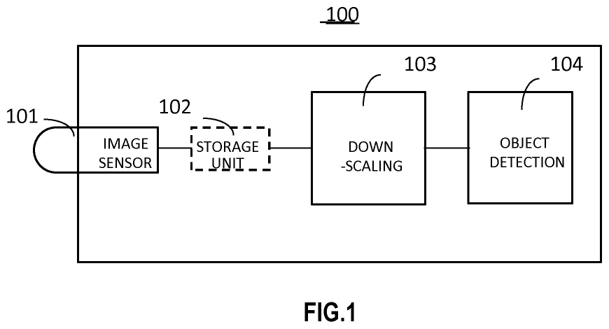

With reference to FIG. 1, a conventional object detection system 100 includes an image sensor 101 for capturing video, a downscaling module 103 and an object detection module 104. The captured video is either stored in a storage unit 102 or processed for object detection by the down scaling module 103 and object detection module 104. The down scaling module 103 conditions the source video data to render compression more appropriate for the operation in the object detection module 104. The compression is rendered by reducing the frame rate and resolution of the captured video. In some other object detection system (not shown), the compressed video frames may be further encoded and streamed to a remote device for further analysis or an operator to act upon the event shown in the video. An object detection is often carried out by performing a detection model or algorithm which is often machine learning or deep learning based. The detection model is applied to identify all objects of interests in the video. There are several advantages of doing the object detection closer to the image sensor as the resolution of the video is higher and there is a tighter loop between the object detector and the control of the image sensor. However, the complexity of the detection algorithm is increased with the increase of input resolution. It becomes more complex when there are too many objects in the scene or when contextual understanding is needed to be performed which is typically too resource demanding in a small and power-constrained near sensor device. Cropping a fraction of the video frames at full resolution may simplify the task of object detection within that cropped region, but there will be no analysis for the area outside that cropped region of the video frames.

With regards to dealing with the challenge of the small object detection, previous work can be classified into three categories:

Using downscaled image for detecting both small and big objects, thus largely suffering from accuracy drop for small objects, wherein the so-called big objects refer to the objects with a higher number of pixels in a video compared to the small objects. In this approach, the input image is downscaled, and thus the object detection model does not utilize high-resolution image captured by the image sensor. Example work based on this approach is disclosed in “Faster r-cnn: Towards real-time object detection with region proposal networks” by Ren, Shaoqing, et al., published in Advances in neural information processing systems in 2015.

Using downscaled image but modifying certain parts of the network topology to better detect small objects. A common practice to cope with the problem of small object detection is disclosed in “Feature pyramid networks for object detection.” by Lin, Tsung-Yi, et al., published in Proceedings of the IEEE Conference on Computer Vision and Pattern Recognition in 2017. Similar to the aforementioned approach, this approach does not exploit the high-resolution input image when available.

Using a downscaled image for coarse grained object detection and exploiting the high-resolution image when necessary. This approach was introduced in “Dynamic zoom-in network for fast object detection in large images” by Gao, Mingfei, et al, published in Proceedings of the IEEE Conference on Computer Vision and Pattern Recognition in 2018, where a reinforcement learning algorithm was used to progressively find regions of interests (ROIs) which is then processed in the object detection pipeline. In this approach, the detection of small and large objects is not explicitly separated, and the challenge of small object detection is not specifically addressed.

The use of a single model for detecting objects of all different classes or sizes has proven problematic, thus the need for decoupled but collaborative models where each model specialized in detecting certain class of objects and/or certain size of objects could be a better alternative. We propose to follow the latter approach. The term “size” refers to a resolution in number of pixels and does not necessarily reflect a physical size of an object in real life.

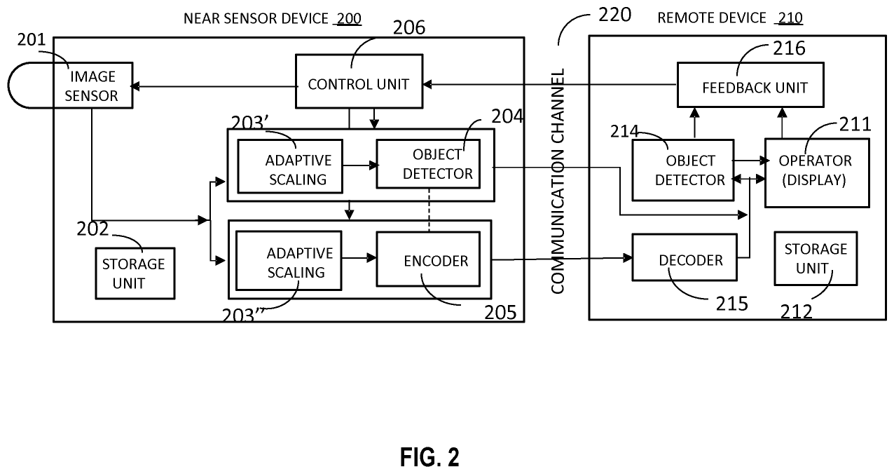

FIG. 2 is a block diagram schematically illustrating a collaborative object detection system according to an embodiment of the present invention. The system may comprise a near sensor device 200 and a remote device 210. The near sensor device 200 may be an electronic device or a machine or vehicle comprising an electronic device that can be communicatively connected to other electronic devices on a network, e.g. a remotely controlled machine equipped with a camera, a surveillance camera system, or other similar devices. The network connection between the near sensor device 200 and the remote device 210 may be established wirelessly or wired, and the network comprises telecommunication network, local area network, wide area network, and/or the Internet. The near sensor device 200 is often some device with limited resources in size or power consumption and/or driven by battery. The remote device 210 may be a personal computer (either desktop or laptop), a tablet computer, a computer server, a cloud server or a media player.

As depicted in FIG. 2, an example near sensor device 200 comprises an image sensor 201, e.g. a camera, a first adaptive scaling module 203′, a second adaptive scaling module 203″, an object detector 204, an encoder 205, and control unit 206. The object detector 204 may detect (comprising identify and/or track) objects in the video data captured by the image sensor 201 and may provide a side information comprising the information of the detected objects to the communication channel 220. The object detector 204 may generate data indicating whether one or more object is detected in the video and if so, where the objects were found, what classes the detected objects belong to, and/or what sizes the detect objects have. The object detector 204 may detect the presence of a predetermined class of objects in the received source video frames. Typically, the object detector 204 may output the representing pixels coordinates, the class of a detected object within the source video frames, and corresponding factor of detection certainty. The coordinates of an object may define, for example, opposing corners of a rectangle representing the detected object. The size of the object may be inferred from the coordinates information. The encoder 205 may encode video data captured by the image sensor 201 and may deliver the encoded video data to a communication channel 220 provided by the network. In some other embodiment, the example near sensor device 200 comprises a storage unit 202 (e.g. memory or any type of computer readable medium) for storing the captured video frames of the video before encoding and object detection.

The scaling parameters of the adaptive scaling modules 203′ and 203″ define frame rate down-sampling (or spatial down-sampling) and resolution down-sampling (or temporal down-sampling), wherein scaling refers to a relation between an input video from the image sensor 201 and a video ready to be processed for encoding or object detection. In an exemplary embodiment, the object detector 204 or the encoder 205 selects its own scaling parameters based on the contents of video and its own operation rate. The object detection operates in parallel with the encoding of the video frames in the near sensor device 200, and the object detector 204 and the encoder 205 may have the same or different operation rates. For example, the image sensor 201 provides high-resolution frames in 60 frame per second (fps), but the encoder 205 operates in 30 fps which means every second frame is encoded by the encoder 205 and the frame rate down-sampling is 2. If the object detector 204 analyses every second frame, the frame rate down-sampling for object detection is also 2, the same as that for video encoding. The adaptive scaling modules 203′ and 203″ are parts of the object detector 204 the encoder 205, respectively. In the exemplary embodiment, the object detector 204 analyses the second frame and drops the first frame and the encoder 205 operates on every second frame and skips the rest of frames. Alternatively, the adaptive scaling modules 203′ and 203″ may be implemented as separate parts from the object detector 204 and the encoder 205. The adaptive scaling modules 203′ and 203″ condition the source video data to render compression more appropriate for the operation in the object detector 204 and the encoder 205 respectively. The compression is rendered by either reducing the frame rate and resolution of the captured video or remaining the same as the source video data. In another exemplary embodiment, the object detector may operate in sequence or in parallel with encoding the video frames in the near sensor device 200. The object detector 204 may work on the same frame as the encoder 205 before or in parallel with the frame rate down-sampling for the encoder 205. The object detector 204 may communicate with the encoder 205 as illustrated by the dash line. For example, the object detector 204 may provide the information about regions to the encoder 205. The information may be used by the encoder 205 to encode those regions with an adaptive encoding quality. The scaling parameters of the adaptive scaling modules 203′ and 203″ as parts of the configuration of the near sensor device 200 are subject to adapt or update upon instructions from the control unit 216.

The object detector 204 is configured to detect and/or track at least one object in the scaled video with the first set of adaptive scaling parameters using a near sensor object detection model. The near sensor object detection model is often machine learning (ML) based and may comprise several ML models where each of the models is utilized for a certain size or class of objects to be detected. A ML model comprises one or more weights. The control unit 206 is configured to train the ML model by adjusting the weights of the ML model or select a new ML model for detecting a new size or class of objects. In one exemplary embodiment, the motion vectors from the encoder 205 may be utilized for the object detection, especially for a low complexity tracking of moving objects, which can be conducted by using spatial-temporal Markov random field. This can also be relevant for stationary camera sensors, where changes in the scenes could be good indications of potentially relevant objects. In another embodiment, a tandem learning model is used as the near sensor object detection model. The object detector 204 progressively identifies the ROIs in a high-resolution video frame and accordingly detects objects in those identified regions. In a third embodiment, the near sensor detection model uses temporal history of past frames to detect objects in the current frame. The number of past frames is determined during the training of the object detection model. To resolve confusions about mixed objects in a video, the object detector 204 performs object segmentation. The output of the object detector 204 comprises the information of the detected and/or tracked at least one object in the video. The information of the detected and/or tracked objects comprises a pair of the coordinates defining a location within a video frame, the size or the class of the detected objects, or any other relevant information relating to the detected one or more objects. The information of the detected and/or tracked objects will be transmitted to the remote end for object detection operation in the remote end device 210. In an exemplary embodiment, the small objects or a subset of them are detected and continuously tracked and the corresponding information is updated in the remote end device 210. In another exemplary embodiment, the object detection in the near sensor device 200 is only for finding new objects coming to the view, then the information of the found new objects is communicated to the remote end device 210 by a side information. The remote end device 210 performs object tracking on the new-found objects using the received information from the near sensor device 200. The near sensor object detection model as a part of the configuration of the near sensor device 200 is subject to adapt or update upon instructions from the control unit 216.

The encoder 205 is configured to encode a video scaled with a second set of adaptive scaling parameters using an encoding quality parameter. In an exemplary embodiment, the high-resolution video captured by the image sensor 201 may be down-sampled with a sampling factor of 1 meaning that a full resolution video is demanded. Otherwise, the frame rate and resolution of the video is reduced. The scaled video after the frame rate down-sampling and resolution down-sampling is encoded with a modern video encoder, such as H.265, and the like. The video can be encoded either with a constant encoding quality parameter or with an adaptive encoding quality parameter based on regions, e.g. ROIs with potential objects are encoded with a higher quality by using a low Quantization Parameter (QP) and the other one or more regions are encoded with a relatively low quality. The encoding quality parameter in the encoder 205 comprises the QP parameter and determines the bitrate of the encoded video streams. In another exemplary embodiment, each frame in the scaled video can be separated into tiles, and tile-based video encoding may be utilized. Each tile containing a ROI is encoded with a high quality and the rest of the tiles are encoded with a low quality. The encoding quality parameter as a part of the near sensor device 200 is subject to adapt or update upon instructions from the control unit 216.

The near sensor device 200 further comprises a transceiver (not shown) for transmitting a data stream to the remote device 210 and receive a feedback from the remote device 210. The transceiver merges the encoded video data provided by the encoder 205 with other data streams, e.g. the side information from the object detector 204 or another encoded video stream provided by another encoder in parallel with the encoder 205. All the merged data streams are conditioned for transmission to the remote device 210 by the transceiver. The side information such as coordinate and the size or class of at least one detected object may be embedded in the Network Abstraction Layer (NAL) unit according to the corresponding video coding standard. The data sequences of this detected information may be compressed with entropy coding and the encoded video stream together with the associated side information are then transported to the remote device using Real-time Transport Protocol (RTP). The side information together with the encoded video data may be transmitted using MPEG Transport Stream (TS). The encoded video streams and the associated side information can be transported using any applicable standardized or proprietary transport protocols. Alternatively, the transceiver sends the encoded video data and the side information separately and/or independently to the remote device 210, e.g., when only one of the data streams is needed at a time or required by the remote device 210. The associated side information is preferably transmitted in a synchronous manner so that the information of detected objects is matched to the received video frame at the remote device 210.

The control unit 206 may comprise a processor, microprocessor, microcontroller, digital signal processor, application specific integrated circuit, field programmable gate array, any other type of electronic circuitry, or any combination of one or more of the preceding. The control unit 206 is configured to receive a feedback from a remote device and update the configuration of the near sensor device by controlling the coupled components (201, 203′, 203″, 204, 205) in the near sensor device 200 upon receiving a feedback. In some exemplary embodiment, the control unit 206 may be integrated as a part of the one or more modules in the near sensor device 200, e.g. object detector 204, the encoder 205. The control unit 206 may comprise a general central processing unit. The general central processing unit may comprise one or more processor cores. In particular embodiments, some or all the functionality described herein as being provided by the near sensor device 200 may be implemented by the general central processing unit executing software instructions, either alone or in conjunction with other components in the near sensor component device 200, such as memory or storage unit 202.

The components of near sensor device 200 are each depicted as separate boxes located within a single larger box for reasons of simplicity in describing certain aspects and features of near sensor device 200 disclosed herein. In practice however, one or more of the components illustrated in the example near sensor device 200 may comprise multiple different physical elements (e.g., object detector 204 and encoder 205 may comprise interfaces or terminals for coupling wires for a wired connection and a radio transceiver for a wireless connection to the remote device 210).

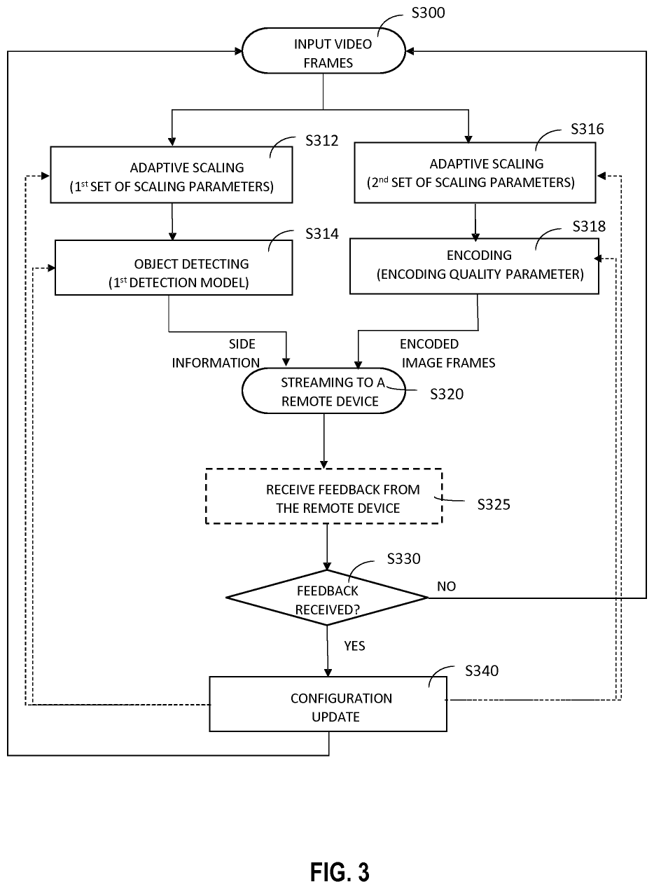

FIG. 3 is a flow chart illustrating a method performed in a near sensor device 200 according to an embodiment. The method may be preceded with receiving (S300) input video frames from the image sensor 201. The input video frames are in parallel scaled with a first set of scaling parameters by the adaptive scaling module 203′ (S312) and a second set of scaling parameters by the adaptive scaling module 203″ (S316). The object detector 204 starts detecting at least one object in the video scaled with the first set of scaling parameters, using a first detection model (S314). The encoder 205 starts encoding the video scaled with the second set of scaling parameters, using an encoding quality parameter (S318). The encoded video, an associated side information comprising the information of the detected at least one object, or both are transmitted or streamed to a remote device 210 (S320). The streaming S320 can be carried out using any one of real-time transport protocol (RTP), MPEG transport stream (TS), a communication standard or a proprietary transport protocol. Any of the scaling parameters and the encoding quality parameter is configured so that the bitrate of the streaming is less than or equal to the bitrate limitation of the communication channel between the near sensor device 200 and the remote device 210. The information of the detected object may comprise coordinates defining the location within a video frame, a size or a class of the detected at least one object or combination thereof. The side information may comprise metadata describing the information of the detected at least one object. If both the video stream and the associated information are streamed, they must be synchronized at the reception on the remote device 210. A control unit 206 determines whether a feedback has been received from the remote device (S330). If a feedback is received from the remote device (S325), the control unit 206 updates the configuration of the near sensor device 200 (340) based on the received feedback. The configuration update comprises adapting or updating any of the first set of scaling parameters, the second set of scaling parameters, the first detection model and the encoding quality parameter as indicated by the dash lines.

The detected at least one object in S314 may be from a ROI in the video. The detected at least one object may also be a new object or a moving object in a current video frame compared to temporal history of past frames. The number of past frames is determined during the training of the first detection model in the object detector 204. If the detected at least one object is moving, detecting at least one object also comprises tracking of the at least one moving object in the video.

The feedback from the remote device 210 in S330 may comprise a constraint of a certain class and/or size of object to be detected. The remote device 210 may find certain classes of objects that are more interesting compared to the other classes. For example, for a remotely controlled excavator, the remote device 210 would like to detect where all the electronic cords or water pipes are located. The class of object to be detected would be cord or pipe. For small objects that have too low resolution to be easily detected in the near sensor device 200, the constraint of such objects would be defined by the size or resolution in number of pixels, e.g., object with less than 20 pixels. If the remotely controlled excavator operates in a mission critical mode, the operator on the remote device side 210 does not want to have human in the scene. The remote device 210 may set up the class of object to be human. The near sensor device 200 will update the remote device 210 immediately once a human is detected and the remote device 210 or the operator may have time to send a warning message. The control unit 206 may instruct the object detector 204 to adapt the first detection model according to the constraint received from the remote device 210. If the first detection model is a ML model, adapting the first detection model may be to adapt the weights of the ML model or select a new ML model suitable for the constrained class and/or size of object to be detected.

The feedback from the remote device 210 in S330 may comprise an information or suggestion of a ROI. The remote device 210 may be interested in viewing certain part of the video frames in a higher encoding quality, after viewing the received encoded video and/or the associated side information. The control unit 206 will increase the resolution by adapting the second set of parameters and/or adjusting the encoding quality parameter of the encoder 205 for the suggested ROI. The encoder 205 may crop out the area corresponding to the suggested ROI, condition the cropped video with the updated second set of scaling parameters for encoding, and encode it with the updated encoding quality parameter. The encoded cropped video may be streamed to the remote device 210 in parallel with the original existing video stream. To fulfill the bitrate limitation of the communication channel 220, the bitrate for the existing video streams needs to be reduced accordingly. The encoding quality parameter for each encoded video stream needs to be adapted accordingly. The cropped video may be encoded and streamed alone. If the encoded cropped video is transmitted to the remote device with an associated side information, the side information may comprise the information of the detected objects in the full video frame. The remote device 210 will get an encoded video for the suggested ROI in a better quality at the same time a good knowledge about the video in full frame based on the associated side information. Updating the configuration of the near sensor device 200 may comprise updating the configuration of the encoder 205, e.g. adjusting ROI to be encoded, initiating another encoded video stream, based on the received feedback.

The feedback from the remote device 210 in S330 may also be a zoom-in request for examining a specific part of the video. The control unit 206 updates the zoom-in parameter of the image sensor 201 according to the request. To some extent, the zoom-in area may be considered as a ROI for the remote device 210. The configuration of the near sensor device 200 comprises a zoom-in parameter to the image sensor 201.

The feedback from the remote device 210 in S330 may further comprise a rule of triggering on detecting an object based on a class of object or at certain ROI. In an exemplary embodiment, the remote device 210 may go to sleep or operate in a low power mode, or bandwidth of the communication channel 220 between the near sensor device 200 and the remote device 210 is not good enough for carrying out a normal operation, or others. The rule of triggering may be based on movements from previous frames (to distinguish from previously detected stationary objects) or only trigger on object detected at certain ROI. The rule of triggering may be motion or orientation based. The feedback from the remote device 210 may require the near sensor object detector 204 detects moving objects (i.e. the class of object is moving object) and update the remote device 210 of the detected moving objects. Otherwise no update from the near sensor device 200 to the remote device 210 is needed. This rule-based feedback is very beneficial when the near sensor device 200 or the remote device 210 is powered by battery. The near sensor device 200 does not need to detect all but selected objects in the video based on feedback from the remote device 210. In another exemplary embodiment, the remote device 210 does not need to be awake all the time to wait for the update or streamed data from the near sensor device 200. Upon receiving the feedback, the control unit 206 may adjust or update the first set of scaling parameters for the object detector 204 to operate on a full resolution of the input video defined by the image sensor 201. This is particularly relevant when the bandwidth of communication channel is very limited or unstable or in a particular embodiment the video storage unit on the remote device 210 is not enough to receive more video data. In this scenario, no video frames be encoded by the encoder 2015 and only the associated side information is to be transmitted to the remote device 210.

The power consumption on the near sensor device 200 can be further saved when a received feedback from the remote device 210 indicates no change in the result of object detection and the task of object detection is non-mission-critical. The control unit 206 may turn the near sensor device 200 into a low-power mode (e.g. a sleeping mode or other modes consuming less power than a normal operation mode). Updating the configuration of the near sensor device 200 may comprise turning the near sensor device 200 into a low-power mode. When a mission is critical, the near sensor device 200 operates in a mission critical mode and may notify the remote device 210 about a potential suspicious object with the side information in a high priority compared to the video stream. This is to avoid potential delays related to video frame packet transmission and decoding. This side information transmission with a high priority may be streamed through a different channel in parallel with the video stream.

Again, with reference to FIG. 2, an example remote device 210 comprises a transceiver (not shown), an object detector 214, a decoder 215 and a feedback unit 216. The transceiver may receive a streaming data from the near sensor device 200 via the communication channel 220 and parse the received data into various data streams, e.g. video data, information of the detected one or more objects at the near sensor end, and other types of data relating to the context of object detection. The transceiver may transmit a feedback to the near sensor device 200 when it is needed via the communication channel 220 provided by the network. The feedback may be transmitted using Real-time Transport Control Protocol (RTCP). The example remote device 210 may comprise a storage unit 212 (e.g. memory or any type of computer readable medium) for storing video and/or any other received data from the near sensor device 200. In some embodiment, the example remote device 210 may comprise an operator 211 that has a visual interface (e.g., a display monitor) to the output of object detector 214 and/or the decoder 215.

The decoder 215 is configured to decode the encoded video from the near sensor device 200. The decoder 215 may perform decoding operations that invert encoding performed by the encoder 205. The decoder 215 may perform entropy decoding, dequantization and transform decoding to generate recovered pixels block data. The decoded video may be rendered for display, stored in the storage unit 212 for later use, or both.

The object detector 214 in the example remote device 210 is configured to detect at least one object in the decoded video using a remote end detection model. The remote end detection model may be a ML model. Like in the near sensor end, the remote end detection model may also use temporal history of past frames to detect objects in the current frames. The number of past frames is determined during the training of the corresponding object detection model in some embodiment. The remote end device 210 may have less constraint on power and computation complexity compared to the near sensor device 200. A more advanced object detection model can be employed in the object detector 214.

The operator 211 may be a human monitoring a monitor. In an exemplary embodiment, the encoded video is displayed on the monitor for the operator 211. The received side information, if any, may be an update on new objects coming to the view found by the object detector 204 at the near sensor device 200. The side information may also be the information of objects in certain size or class (e.g. small objects or a subset of them) that are detected and continuously tracked at the near sensor device 200. Such information may comprise the coordinates defining the position of the detected objects, the sizes or classes of the detected objects, other relevant information relating to the detected one or more objects, or combination thereof The received information may be displayed for the operator 211 on a monitor in another exemplary embodiment.

The feedback unit 216 may comprise a processor, microprocessor, microcontroller, digital signal processor, application specific integrated circuit, field programmable gate array, any other type of electronic circuitry, or any combination of one or more of the preceding. The feedback unit 216 is configured to determine whether a feedback to the near sensor device 200 is needed based partially at least on a contextual understanding on any of the received side information, the decoded video and the output of the object detector 214.

In a first exemplary embodiment, the operator 211 in the remote device 210 may be interested in viewing certain part of the video frames in a higher encoding quality, after viewing the received encoded video and/or the associated side information. The remote operator 211 may send an instruction to the feedback unit 216 which further sends a request for a new video stream with an updated ROI as a feedback to the near sensor device 200, where the request or feedback comprises the information of a ROI and a suggested encoding quality. The control unit 206 in the near sensor device 200 receives the feedback and then instructs the encoder 205, according to the received feedback. The encoder 205 may adjust its encoding quality parameter and deliver an encoded video with high quality encoding in the suggested ROI to the remote end 210. Alternatively, the encoder 205 may initiate a new video stream for the suggested ROI encoded with high quality in parallel with the original video stream with a constant quality encoding. The additional video stream can be shown on an additional display in the operator side 211.

In a second exemplary embodiment, the operator 211 may send a “zoom-in” request for examining a specific part of a video as the feedback to the near sensor device 200. The feedback may comprise the information of a ROI and a suggested encoding quality. Upon receiving the feedback at the near sensor device 200, the control unit 206 instructs the encoder 205 to crop out the ROI, and encode the cropped video using the updated encoding quality parameter, and then transmit the encoded video to the operator 211. Alternatively, the control unit 206 may control the image sensor to capture only the ROI and provide the updated video frames for encoding. The encoded cropped out video may be transmitted in parallel with the original video stream to the remote device 210. When the remote end device 210 only receives the zoom-in part of the video, an associated side information comprising the information of detected one or more objects for the full video frame is transmitted to the remote device 210 as well. The side information may be shown as text information on the display, e.g. the coordinates and classes of all the objects detected on the full video frame by the near sensor device 200.

In a third exemplary embodiment, the object detector 214 analyses received decoded video and/or the associated side information from the decoder 215 and concludes that the detection results of the object detector 214 in the remote device 210 are always identical to that of the object detector 204 in the near sensor device 200 and the detection results of the object detector 214 have not changed in the past predefined duration of time, e.g. no new objects found, or the coordinates defining the positions of the detected one or more objects remain the same. Alternatively, this can be manually detected by the operator 211 by visually observing the decoded video and/or reviewing the received side information. Based on the detection results, the feedback unit 216 understands that there will probably be no change in the following video stream and then send a feedback to the near sensor device 200, where the feedback comprises an instruction to turn the image sensor 202 into a low power mode or turn off the image sensor 201 completely if the task on the near sensor device 200 is non-mission-critical. The object detector 204 and video encoder 205 will then turn to either a low power mode or off mode accordingly. Less data or no data will be transmitted from the near sensor device 200 to the remote device 210. This can be very important for a battery-driven near sensor device 200. The collaborative detection provides more potential for power consumption optimization. If the amount of energy is limited at the sensor device 200 (e.g. a battery-powered devices) and power consumption need to be reduced, the remote device 210 can provide control information as the feedback to the near sensor device 200 with respect to object detection to reduce the amount of processing and thereby lower the power consumption on the near sensor end 200. That can range from turning off the near sensor object detection during certain periods of time, to focus on certain parts of scenes, lower the frequency of inferences, or others. If both near sensor device 200 and remote device 210 are powered by battery, an energy optimization strategy can be executed to balance the energy consumption for a sustainable operation.

The collaborative detection also allows that the task of object detection is shared by both the near sensor device 200 and the remote device 210, for example, when the transmission channel 220 is interfered or in a very bandwidth limited situation, which can cause either severe packet-drop or congestion, or the storage unit 212 at the remote device 210 has less storage for video. In an exemplary embodiment, the remote end device 210 may notify the near sensor device 200 to increase its capacity for object detection and only send the side information comprising the information of detected one or more objects to the remote device 210. In another exemplary embodiment, the remote end device 210 may set a target video resolution and/or compression ratio for the near sensor device 200 so that the bitrate of the encoded video at the near sensor device 200 can be reduced. The object detector 204 in the near sensor device 200 operating on full resolution allows critical objects (e.g. small objects, or objects that are critical to the remote end device 210) to be detected. The remote end device 210, based on more advanced algorithms and contextual understanding, can set up rules to reduce the bitrate of the encoded video, but the object detector 204 in the near sensor device 200 exploits the full resolution video frames and provides key information of the detected object to the remote device 210 allowing that to fall back to a higher bitrate based on the key information of the detected objects. In such scenarios, the remote device 210 can provide rules as the feedback to the near sensor object detector 204, e.g. to only trigger on new objects based on movements from previous frames (to distinguish from previously detected stationary objects) or to only trigger on object detected at certain ROI.

The rule-based feedback may also be used for changing weights of the ML model in the near sensor object detector 204. The remote device 210 may only ask the near sensor device 200 to report certain classes of object. In a fifth exemplary embodiment, the remote operator 211 sends a request to the near sensor device 200 for detecting objects in a special set of classes (e.g. small objects, cords, pipes, cables, humans). Upon receiving the instructions from the remote device 210, the object detector 204 in the near sensor device 200 loads the corresponding weights for its underlying ML algorithm. The weights were specifically trained for this set of classes. Alternative to changing weights of the first object detection model, the first object detection model may be updated with a completely new ML model for certain class of objects. The near sensor object detector 204 may use a tandem learning model to identify the set of classes for detection which satisfy certain rules defined in the rule-based feedback, e.g. motion, orientation etc. The feedback from the remote device 210 may require the near sensor object detector 204 detects moving objects only and updates the remote operator about the new detections. The remote device 210 may sleep or run in a low-power mode and wake up or turn to a normal mode when receiving the update of the new detections from the near sensor device 200. The information about stationary objects are communicated to the remote device 210 less frequently and not updated to the remote device 210 when such objects vanishes from the field of view of the image sensor 201.

The feedback unit 216 may learn the context from the actions of an operator for an ROI and objects of interest. This could be inferred from, for example, the regions the operator 211 zooms in very often, or the most frequent gazed locations if gaze control e.g. a head-mounted display, is used. Upon obtaining the context, the feedback unit 216 can provide a feedback to the near sensor device 200 which then adjusts the bit-rate for that ROI. The feedback may possibly provide a suggestion to update the models and weights for the detection on the near sensor object detector 204.

Small objects are often detected in a low rate at the near sensor end, e.g. 2 fps, and the information of the detected one or more small objects is transmitted to the remote end device 210. The detection rate of the object detector 204 can be adapted to always maintain a fresh view in the remote end device 210 about the detected one or more small objects. In this case, the feedback from the remote device 210 comprises a suggested frame rate down-sampling for object detection.

The feedback unit 216 may comprise a general central processing unit. The general central processing unit may comprise one or more processor cores. In an embodiment, some or all the functionality described herein as being provided by the remote device 210 may be implemented by the general central processing unit executing software instructions, either alone or in conjunction with other components in the remote device 210, such as memory or storage unit 212.

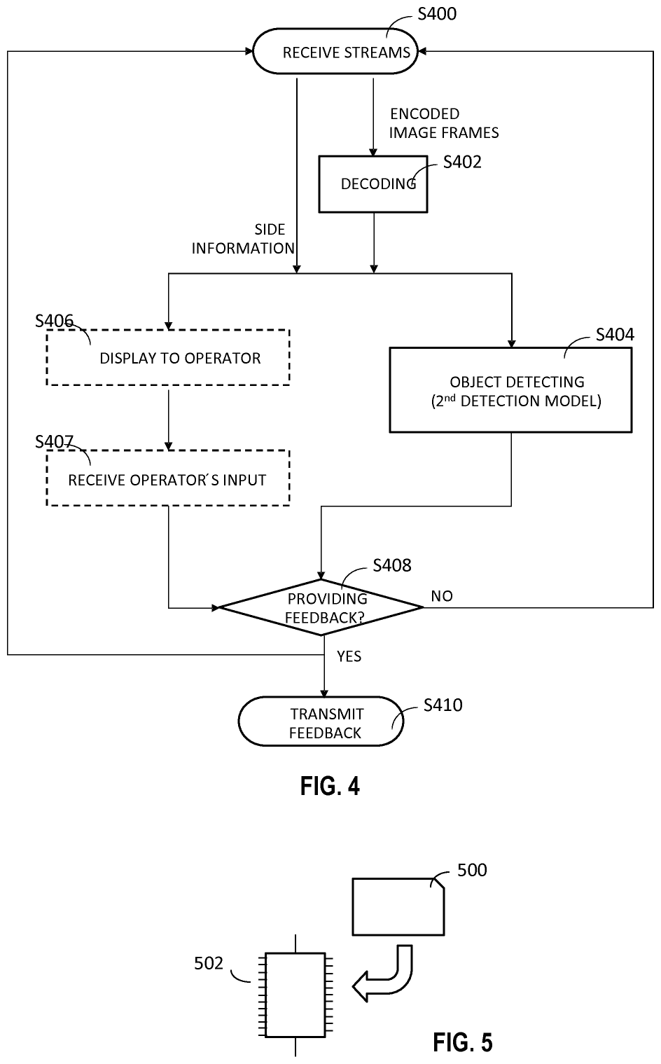

FIG. 4 is a flow chart illustrating a method performed in a remote device 210 according to an embodiment. The method may begin with receiving streams from a near sensor device 200 (S400). The streams or steaming data may comprise an encoded video. The decoder 215 performs decoding on the encoded video (S402). The object detector 214 performs object detection on the decoded video using a second detection model (S404). The second detection model comprises an algorithm for object detection, tracking and/or performing contextual understanding. If a display monitor is provided in the remote device 210, the encoded video may be displayed to an operator 211 (S406). A feedback unit 216 determines a feedback to the near sensor device 200 when it is needed, based on partially at least a contextual understanding on any of the decoded video and the result of the object detection (S408). An input to the feedback unit 216 may be received from the operator (S407) based on the encoded video. The feedback unit 216 will then transmit the feedback to the near sensor device 200 (S410). The streaming data may further comprise a side information associated to the encoded video, where the side information comprises the information of at least one object in the encoded video. The received side information may be displayed to the operator 211 (S406). The input received from the operator (S407) may be based on the encoded video, the side information or both. The feedback unit 216 may determine the feedback based on partially at least a contextual understanding on any of the received side information, the decoded video and the result of the object detection (S408).

Transmitting the feedback in S410 may comprise providing the feedback comprising a request for an encoded video with a higher quality or bitrate for a ROI than the other one or more regions. For example, after viewing the decoded video and/or the associated information of the detected one or more objects in the near sensor device 200, the operator 211 in the remote device 210 may understand the environment of the near sensor device 200, e.g. full of cables, pipes, and some identified small objects. To find out more information about those identified small objects, the operator 211 may be interested in viewing certain part of the video frames where those identified small objects were found in a higher encoding quality. Transmitting the feedback in S410 may comprise providing the feedback comprising a “zoom-in” request for examining a specific part of a video. The feedback may further comprise the information of the ROI and a suggested encoding quality so that the near sensor device 200 can make necessary update on its own configuration based on the feedback information.

Transmitting the feedback in S410 may comprise providing the feedback comprising a constraint of a certain class and/or size of object to be detected. The remote device 210 may understand that certain classes of objects are more critical than the others in the current mission. When the near sensor device 200 operates in a mission-critical-mode and the operator on the remote device 210 does not want to have certain class of objects in the scene. The remote device 210 may set up the constraint and request the near sensor device 200 update the remote device 210 immediately upon the detection of an object from such constrained class of objects. The feedback may also be provided upon instructions from the operator 211.

A contextual understanding may be a resource constraint, e.g. the quality of decoded video on the display to the operator 211 is declined which may be caused by an interfered communication channel, or loading up the decoded video on the display takes a longer time than usual indicating a limited video storage in the remote device 210 or a limited transmission bandwidth. The feedback unit 216 may upon a detection of the resource constraint, provide a feedback comprising a request for reducing the bitrate of the streaming data. The resource constraint may also comprise power constraint on any of the near sensor device 200 and the remote device 210 if any of the devices 200, 210 is a battery-driven device. The near sensor device 200 may report the battery status to the remote device 210 on a regular basis. The battery status of the near sensor device 200 may be comprised by the side information. The provided feedback may be rule-based, e.g. requesting the near sensor device 200 only detect certain class of objects or update the remote device 210 only upon triggering on detecting certain class of objects.

The provided feedback may comprise a request to the near sensor device 200 to carry out object detection in a full resolution video frames and transmit only the information of the detected at least one object to the remote device 210 without providing the associated encoded video. If both near sensor device 200 and remote device 210 are powered by battery, this provided feedback may be based on an energy optimization strategy that can be executed to balance the object detection task and the energy consumption for a sustainable operation.

The feedback unit 216 may upon the result of the object detection indicating no change in the video frames of the video and the task of object detection is non-mission-critical, provide a feedback of no further streaming data is needed until a new trigger of object detection is received. This is based on a contextual understanding that there will probably be no change in the following video stream, based on the output of the object detector 214 and the information of the detected one or more objects in the near sensor 200. This contextual understanding may be automatically performed by the object detector 214 or manually consolidated by the operator 211 when visually observing the decoded video.

According to some exemplary embodiment, the contextual understanding is learned from an action of the operator on the decoded video, and the feedback comprises a suggested region or object of interest based on the contextual understanding. This could be inferred from, for example, the regions of the decoded video that the operator 211 zooms in very often, or the most frequent gazed locations if a head-mounted display is used.

As an overview of the whole system in FIG. 2 according to an exemplary embodiment, the complete system consists of (i) an object detector 204 suitable for small object detection working at image sensor-level resolution in parallel with a video encoder 205, (ii) a video encoder 205, which could be a state-of-the-art encoder and provide a video stream comprising the encoded video, (iii) the mechanisms to send information about detected one or more objects as synchronized side-information with the video stream, (iv) feedback mechanisms from remote end to (a) improve small object detection by receiving information from remote device 210 on regions of potential interests, and/or (b) change video stream to an area around detected objects of interest and/or (c) add a parallel video stream on regions where objects of interest have been detected (potentially with a reducing bit-rate of the original video stream because of overall limited bit-rate required by the communication channel for transmitting the video streams) and/or (d) to optimize the video compression taking into consideration the regions of the detected objects of interest, and/or (e) update or limit the class of objects being considered in the near-sensor object detector 204 and/or (f) to optimize/balance the power consumption in the near sensor device 200 and remote end device 210. The proposed solution allows to decouple the object detection task between the near sensor front-end and the remote-end, to overcome the limitations of limited resources in size, power consumption, cost on the near sensor device 200, limited communication bandwidth between the near sensor device 200 and the remote device 210 and limited opportunity for the remote device 210 to exploit the high quality source video. This offers certain advantages over conventional solutions and opens a plethora of possibilities on the ways to perform inference tasks, for example: (i) different object detection algorithms can be applied to each side (i.e. near sensor side and remote side). For instance, the object detection on near sensor side may implement a region-based convolutional neural network (R-CNN) whereas the remote side may use a single-shot multibox detector (SSD), (ii) the models at the two sides may perform different tasks. For example, the near sensor side may initially detect the objects, then the remote side only performs object tracking using the information of detected objects from the near sensor side, (iii) adaptive operation modes can be realized by, for example, reducing object detection rate (i.e. frames per second) in either sides depending on the given conditions, e.g. energy, latency, bandwidth.

The methods according to the present invention is suitable for implementation with aid of processing means, such as computers and/or processors, especially for the case where the processing element 206, 216 demonstrated above comprises a processor handling collaborative object detection in video. Therefore, there is provided computer programs, comprising instructions arranged to cause the processing means, processor, or computer to perform the steps of any of the methods according to any of the embodiments described with reference to FIGS. 3 and 4. The computer programs preferably comprise program code which is stored on a computer readable medium 500, as illustrated in FIG. 5, which can be loaded and executed by a processing means, processor, or computer 502 to cause it to perform the methods, respectively, according to embodiments of the present invention, preferably as any of the embodiments described with reference to FIGS. 3 and 4. The computer 502 and computer program product 500 can be arranged to execute the program code sequentially where actions of the any of the methods are performed stepwise, or be performed on a real-time basis. The processing means, processor, or computer 502 is preferably what normally is referred to as an embedded system. Thus, the depicted computer readable medium 500 and computer 502 in FIG. 5 should be construed to be for illustrative purposes only to provide understanding of the principle, and not to be construed as any direct illustration of the elements.

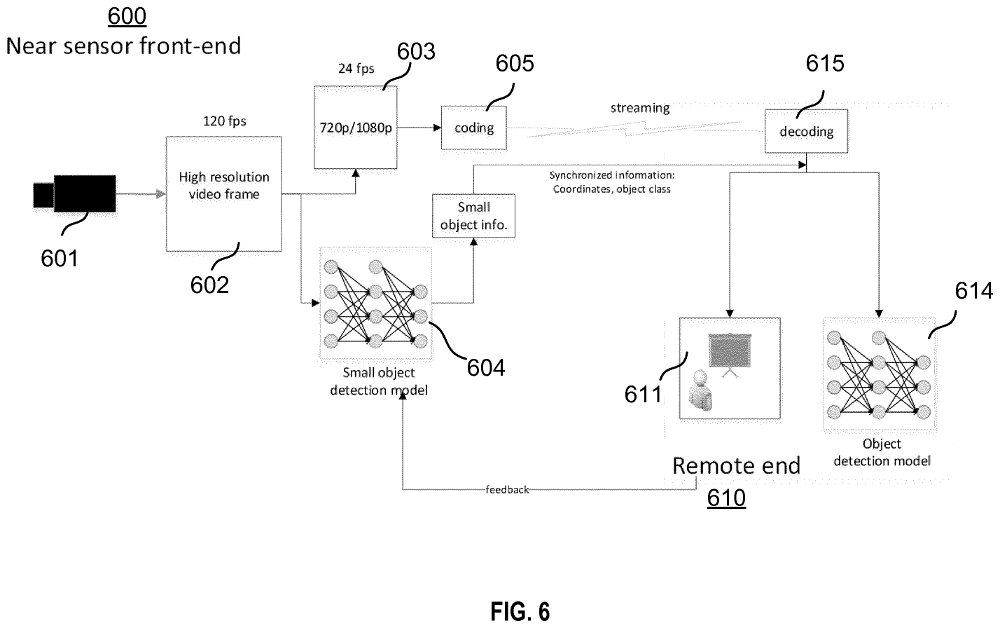

FIG. 6 illustrates an example object detection system for small object detection according to an exemplary embodiment. The example object detection system comprises a near sensor device 600 and a remote device 610. The near sensor device 600 comprises a camera 601 providing a high-resolution video frame 602, e.g. 120 fps to be further processed by the coding module 605 or analysed by the object detector 604. The object detector 604 is using a small object detection model, e.g. R-CNN based, machine or deep learning based. The operation rate of the coding module 605 is only 24 fps. Before the coding module 605 encodes the video, the video frame rate must be down-sampled by 5. The resolution is also down-sampled to either 720P (˜1 Mpixel) or 1080P (˜2 Mpixel) before encoding. The object detector 604 exploits the full resolution video frames and provides the detected small object information. The encoded video and the associated small object information are synchronously streamed to the remote device 610. The remote device 610 comprises an operator 611 having a visual access to both received video and the detected small object information, a decoder 615 decoding the encoded video and rendering it for display and object detection, and an object detector 614 performing object detection and tracking based on the decoded video using an object detection model which may also be R-CNN based, machine or deep learning based. A feedback is provided from the remote device 610 to the near sensor device 600 based on a contextual understanding on any of the decoded video, the received detected small object information and the output of the object detection.

Two example system use cases are provided to further illustrate different embodiments of the invention.

A first use case, a remotely controlled excavator having image sensors at the machinery, transferring video frames to an operator at a separate location. This might be one or several such sensors and video streams. The near-sensor small object detection mechanism identifies certain objects that might be of importance, e.g. electronic cords or water pipes, that might be critical for the operation but difficult to identify at the remote location because of the limited resolution of the video (limiting the remote support algorithms, machine learning for object detection, or to support an operator having multiple video streams in real time with limited resolution). The small objects detected are pointed out by coordinates and a class (e.g. electronic cords or water pipes) allowing the operator (human or machine) to zoom in on that object so that the video catches the object in higher resolution. The operator or automated control might also stop the machinery for evaluation, the video might be adaptively encoded magnifying the area of the identified object, or the region of interest with the small identified object is cropped and sent as a video stream in parallel with the normal video stream (potentially both at half the bitrate if overall bit-rate is limited).

A second use case, a surveillance camera system is based on remote camera sensors sending video to a remote-control room where a human operator or machine-learning system (potentially a human supported by machine-learning algorithms) identifies people, vehicles, and objects of relevance. The near-sensor small object detector identifies a group of people or other relevant objects when they are still far away, sending the coordinates and classification in parallel with, or embedded in, the limited-resolution video stream. This makes it possible for the operator or remote system to act by for example zooming in on the ROI (the objects become large enough to be identified at the remote end), apply adaptively the scaling parameters for encoding increasing the resolution of the relevant part(s) of the view, decides to temporarily increase the resolution of the complete video (if possible and if sufficient), or temporarily add a second video stream with the region of the small objects in parallel with the original video stream (potentially both with reduced bitrate if the total bit rate is limited) or in other ways act upon the relevant information.

In some embodiments, the components described above may be used to implement one or more functional modules used for enabling measurements as demonstrated above. The functional modules or components may comprise software, computer programs, sub-routines, libraries, source code, or any other form of executable instructions that are run by, for example, a processor. In general terms, each functional module may be implemented in hardware and/or in software. Preferably, one or more or all functional modules may be implemented by the general central processing unit in either the near sensor device 200 or the remote device 210, possibly in cooperation with the storage 202 and/or 212. The general central processing units s and the storage 202 and/or 212 may thus be arranged to allow the processing units to fetch instructions from the storage 202 and/or 212 and execute the fetched instructions to allow the respective functional module to perform any features or functions disclosed herein. The modules may further be configured to perform other functions or steps not explicitly described herein but which would be within the knowledge of a person skilled in the art.

Certain aspects of the inventive concept have mainly been described above with reference to a few embodiments. However, as is readily appreciated by a person skilled in the art, embodiments other than the ones disclosed above are equally possible and within the scope of the inventive concept. Similarly, while a number of different combinations have been discussed, all possible combinations have not been disclosed. One skilled in the art would appreciate that other combinations exist and are within the scope of the inventive concept. Moreover, as is understood by the skilled person, the herein disclosed embodiments are as such applicable also to other standards and communication systems and any feature from a particular figure disclosed in connection with other features may be applicable to any other figure and or combined with different features

1. A method performed in a near sensor device connected to a remote device via a communication channel, for object detection in a video, the method comprising:
detecting at least one object in the video scaled with a first set of scaling parameters, using a first detection model;
encoding the video scaled with a second set of scaling parameters, using an encoding quality parameter;
streaming the encoded video to the remote device;
streaming a side information associated to the encoded video to the remote device, wherein the side information comprises the information of the detected at least one object;
receiving a feedback from the remote device; and
updating the configuration of the near sensor device comprising adapting any of the first set of scaling parameters, the second set of scaling parameters, the first detection model and the encoding quality parameter based on the received feedback, wherein
the near sensor device comprises an image sensor, and
the video is captured by the image sensor.

2. The method of claim 1, wherein the detected at least one object is from a region of interest in the video, or the detected at least one object comprises a new or moving object in a current video frame compared to temporal history of past frames.

3. The method of claim 1, wherein the feedback comprises a constraint of class, size or combination thereof on the object to be detected, and the first detection model adapted for detecting object under the constraint.

4. The method of claim 1, wherein the feedback comprises an information of a suggested region of interest, and the second set of scaling parameters and/or the encoding quality parameter are adapted based on regions where the bitrate of the video stream corresponding to the suggested region of interest is higher than the bitrate of the video stream corresponding to the other regions.

5. The method of claim 4, further comprising:
cropping out the area in the video corresponding to the suggested region of interest,
encoding the cropped video scaled with a third set of scaling parameters, using the encoding quality parameter, and
streaming a new video stream comprising the encoded cropped video in parallel with the original video stream,
wherein the third set of scaling parameters provides an increased resolution compared to the second set of scaling parameters, and the side information comprises the information of the detected objects in full video frame.

6. The method of claim 1, wherein the feedback comprises a zoom-in request for examining a specific part of the video, and the configuration of the near sensor device further comprises a zoom-in parameter to the image sensor.

7. The method of claim 1, wherein the feedback further comprises a rule of triggering on detecting an object based on a class of object or a region of interest, upon receiving the feedback the first set of scaling parameters are configured for operating the object detection in full resolution video frames, and the method further comprises streaming only the side information upon detection based on the rule.

8. The method of claim 1, wherein the feedback indicates no change in the detection results and the task of object detection is non-mission-critical, the method comprises updating the configuration of the near sensor device by turning the near sensor device into a low-power mode.

9. The method of claim 1, wherein the information of the detected object comprises a coordinate, a size, a class of the detected at least one object.

10-12. (canceled)

13. The method of claim 1, wherein the streamed encoded video and the associated side information are synchronized at the reception on the remote device.

14. The method of claim 1, wherein the side information is streamed to the remote device in a higher priority than the encoded video or through a different channel in parallel with the video stream.

15-17. (canceled)

18. A method performed in a remote device connected to a near sensor device via a communication channel, for object detection in a video, the method, comprising:
receiving a streaming data comprising an encoded video;
decoding the encoded video;
performing object detection on the decoded video using a second detection model;
determining a feedback to the near sensor device, based on partially at least a contextual understanding on any of the decoded video and the output of the object detection; and
providing the feedback to the near sensor device.

19. The method of claim 18, further comprises receiving a streaming data comprising a side information associated to the received encoded video, wherein the received side information comprises the information of at least one object in the encoded video, and determining the feedback to the near sensor device is further based on a contextual understanding on the received side information.

20. The method of claim 18, wherein the feedback comprises a request for an encoded video with a higher quality for a region of interest than the other regions.

21. The method of claim 18, wherein the feedback comprises a zoom-in request for examining a specific part of the video.

22. The method of claim 18, wherein the feedback comprising a constraint of class, size or combination thereof on the object to be detected.

23. The method of claim 18, wherein upon a detection of a resource constraint, the feedback comprises a request for reducing the bitrate of the streaming data, wherein the resource constraint comprises a low transmission bandwidth of the communication channel or limited storage at the remote-end device.

24. The method of claim 18, wherein upon the result of the object detection indicating no change in the video and the task of object detection is non-mission-critical, the feedback indicates no further streaming data until a new trigger of object detection is received.

25-29. (canceled)

30. A near sensor device for object detection in a video, comprising:
an image sensor for capturing one or more video frames of the video;
an object detector configured to detect at least one object in the captured video scaled with a first set of scaling parameters using a first detection model;
an encoder configured to encode the captured video scaled with a second set of scaling parameters using an encoding quality parameter, wherein the encoded video and/or a side information comprising the information of the detected at least one object in the captured video is to be streamed to a remote device; and
a control unit configured to update the configuration of the near sensor device comprising adapting any of the first set of scaling parameters, the second set of the scaling parameters, the first detection model and the encoding quality parameter, upon receiving a feedback from the remote device,
wherein the near sensor device is configured to communicate with the remote device via a communication channel.

31. A remote device for object detection, comprising:
a decoder configured to decode an encoded video in a streaming data received from a near sensor device, the streaming data comprising the encoded video and/or an associated side information comprising the information of at least one object in the encoded video;
an object detector configured to detect at least one object in the decoded video using a second detection model; and
a feedback unit configured to determine whether a feedback to the near sensor device is needed, based on partially at least a contextual understanding on any of the received side information, the decoded video and the output of the object detector,
wherein the remote device is configured to communicate with the near sensor device via a communication channel.

32-35. (canceled)
